(19) United States
(12) Patent Application Publication
(10) Pub. No.: US 2013/0332845 A1
(43) Pub. Date: Dec. 12, 2013

(54) Apparatus and Method for Utilizing Dynamic Three-Dimensional Facades for Organizing Content

(71) Applicant: VIRTUAL PANORAMICS LLC, Westminster, CO (US)

(72) Inventors: Christopher Ladouceur, Westminster, CO (US); David Ladouceur, Westminster, CO (US); Robert Griffin, Boulder, CO (US)

(73) Assignee: VIRTUAL PANORAMICS LLC, Westminster, CO (US)

(21) Appl. No.: 13/914,440

(22) Filed: Jun. 10, 2013

Related U.S. Application Data
(60) Provisional application No. 61/658,889, filed on Jun. 12, 2012.

(51) Int. Cl. G06F 3/0484; G06F 3/0481

(52) U.S. Cl. CPC G06F 3/0484; G06F 3/04815
USPC 715/744

(57) ABSTRACT

A non-transitory computer readable storage medium has executable instructions to define a landscape of discrete three-dimensional structures. Each three-dimensional structure belongs to one of a group of defined business segments. Each business segment has predetermined façade attributes that provide interactive access to information about a business.

### CROSS-REFERENCE TO RELATED APPLICATION

This application claims priority to U.S. Provisional Patent Application 61/658,889, filed Jun. 12, 2012, entitled, “Apparatus and Method for Utilizing Three-dimensional Facades for Organizing content”, the contents of which are incorporated herein.

### FIELD OF THE INVENTION

The present invention is related to electronic communication networks. More particularly, the invention is directed toward the utilization of three-dimensional facades to organize content.

### BACKGROUND OF THE INVENTION

Content, computer programs and their associated business processes and databases have been traditionally accessed through a static two-dimensional graphic icon or textural representation. Access to content and sub-content within the application requires specialized software applications to be downloaded. These applications are not designed for a touch interface and are hard to use without a pointer device. These icons are static and do not represent any change in the content based on a business's real-time or near real-time status.

Businesses have no ability to publish content with an integrated application framework directly to the internet without creating sophisticated software and applications that require device specific development for a personal computer, laptop, or mobile device and require the use of specific applications stores including The App Store™, The Play Store™, and others. These additional steps hinder a business and a consumer from interacting on a day to day basis, make the addition or management of content difficult and require many steps to perform customer transactions. In addition, these application stores may prohibit a business from operating and may charge additional fees for distributing their application and make the update of an application or change go through an unnecessary approval process.

From a consumer point of view, there is no application on a desktop, laptop, tablet or mobile device that can aggregate their favorite businesses and information into a logical and manageable approach that is synchronized across all devices they own. Most web-site translations today are a poor user experience on the mobile device or tablet, if a user visits a mobile website and has a bad experience they are likely to abandon their task. In addition, there is no organization of favorite businesses by genre including entertainment, news, sports, shopping, dining and drinking establishments, and services.

Therefore, there is a need for a system that can organize content and applications across any device and allow a business to produce content and applications that can be managed without the need of a programmer, an application store for each technology (Android™, IOS™, Windows™, MAC-OS™, Linux™) using a three-dimensional façade that provides an intuitive touch/gesture and pointer device experience.

### SUMMARY OF THE INVENTION

A three-dimensional façade serves as a content portal for a business. The façade is served from a web server to a standard web browser. Each business or service creates a profile on the administrative platform using pre-built infrastructure applications based on their business type and associated category called their district. Districts may include entertainment, news, sports, shopping, dining and drinking establishments, and services districts. A district may be defined for a niche business type.

Using a standard web-browser, a business can upload, provide third party credentials or manually enter data and content to the system. For example, a business admin user may select a three-dimensional façade template or have a custom three-dimensional model built. Using the business administration system, a business admin may associate interactive geometries with their business data and content. Each enabled infrastructure application is automatically associated with its corresponding interactive geometry, which launches the corresponding infrastructure application. The three-dimensional façade geometries operate on any HTML5 compliant browser on any mobile, tablet, laptop and desktop device. The infrastructure applications and any additional third-party applications that are developed can interact with all their business content, end-user content and related meta-data. Consumer infrastructure applications allow content to be accessed and shared across one or more businesses and add additional functionality to provide additional organizational, comparison, search and e-commerce capability.

A published Application Programming Interface (API) allows the extension of business and consumer infrastructure applications and content while maintaining the user experience. An end-user or consumer using a search engine, search engine optimized search or other third party application or directly accessing the businesses website uniform resource location is used to initiate a session with the three-dimensional façade. Logic is used to determine the best approach and method to create the best user experience for the device the facade is displayed on.

The consumer experience is tailored to different levels of detail available based on the device's capability. In one embodiment, a minimum of three levels of detail is included. First, a city view encapsulates all district views using a city block, a reproduction of an existing building or venue, or other three-dimensional landscapes placed in a three-dimensional environment. Second, a zoomed in district view encapsulates all businesses within a District. Third, a façade view focuses on one specific business. Each of these views has dynamic content that can change based on time-of-day, consumer behavior or consumer's social network behavior, sales, promotions, status or information updates that can be provided by the business or third party.

Each Façade has a set of interactive geometries that can be invoked through a standard user interface device or through touch or gestures. The built-in set of interactive geometries that launch infrastructure applications may include an appointment management system, menus for products and services offered, promotions, logo, reviews, advertisements, circulars and catalogues, dining and beverage menus, hours of operation, tickets and event commerce, directions and locations, and an extensible toolbar geometry.

Using a pointer device, touch or gesture the user can interact and transact with the business through the interactive geometries that launch infrastructure applications or other third party applications.

### BRIEF DESCRIPTION OF THE DRAWINGS

The present invention can be better understood by reference to the following figures:

FIG. 1 is a system block diagram of one embodiment of the invention;

FIG. 2 is a further breakdown of the system block diagram that illustrates the details of the City View Controller which manages the overall user experience when viewing a city;

FIG. 3 is a further breakdown of the system block diagram that illustrates the details of the District View Controller which manages the overall user experience when viewing a district;

FIG. 4 is a further breakdown of the system block diagram that illustrates the details of the Façade View Controller which manages the overall user experience when viewing a single business facade;

FIG. 5 is a further breakdown of the system block diagram that illustrates the details of interfacing with third party services using the Meta Data Business Interface to access business information;

FIG. 6 Illustrates process operations associated with a business administrator user to add, change, delete and publish business information through the business administration system;

FIG. 7 Illustrates process operations associated with a business that is acting as an advertiser, sponsor, or promoter to place and operate advertising campaigns within the city, district and façade infrastructures;

FIG. 8a is an example of one of the database elements that stores the business infrastructure application data as well as any third party or admin data;

FIG. 8b is an example of the business applications data base that stores the business application code and any consumer, third party or admin application code;

FIG. 8c is an example of the three-dimensional models that comprise the city, district and façade views;

FIG. 8d is an example of the interactive geometries database that contains the three-dimensional models that launch applications;

FIG. 8e is an example of the user profile and preferences database that stores information about the user and their preferences;

FIG. 8f is an example of the content and advertising database that holds campaigns, advertisements, promotions and other related content;

FIG. 8g is an example of the database containing any third party data or interfaces required to interact with the invention;

FIG. 9a is one embodiment of a three-dimensional façade within a façade view layout and associated interactive geometries;

FIG. 9b is one embodiment illustrating the graphical representation of the façade view;

FIG. 10 illustrates context sensitive features available in the interactive geometry toolbar;

FIG. 11 is one embodiment illustrating the graphical representation of a district;

FIG. 12 is one embodiment illustrating the graphical representation of the special interactive district view;

FIG. 13 is one embodiment illustrating the graphical representation of a city view; and,

FIG. 14 is one embodiment of a sample infrastructure application.

### DETAILED DESCRIPTION OF THE INVENTION

The present invention is an apparatus and method utilizing dynamic three-dimensional facades for organizing content, and hosting business applications for mobile, tablet, laptop, desktop, and smart television devices using a web-browser. The invention provides the capability for a business to interact with their customers on any computing device or mobile phone through a set of built in applications. Programming knowledge or web-design experience is not required. The invention adapts to the device's capabilities and input methods to maximize user friendly interfaces using three-dimensional models and interactive geometries.

In one embodiment, a business is provided templates or custom designed three-dimensional models that illustrate a building façade for the business. Each model has geometry objects that represent pieces of the façade. The geometry objects have attributes including materials, meshes, particle effects, animations, textures and colliders normally found in a three-dimensional modeling system. The invention has extended the usage of these geometry objects to include an interactive element that can provide status, content, animation, or launch a corresponding application through a pointer device or touch/gesturing. Each model can hold multiple interactive geometries and can be customized on a per mode basis.

The Invention provides a set of built-in infrastructure applications that most every business would need to use as part of their day-to-day operations. These applications are stored in a hosted or cloud based repository that can be enabled and customized to each business façade model without programming knowledge. An administrative program is provided to add, change, delete, configure, and load data and establish and link to existing systems including point of sale, web applications, review sites, mapping and directions utilities. Additional applications not part of an interactive geometry for business management would include alerts, and other communications that include email, SMS, MMS and changes in status or availability, search engine optimization, and real-time status. For example, when a customer cancels an appointment through the infrastructure application for appointments, the resources associated with that appointment could be notified by their preferred communication method. In the case where the resource becomes unavailable, the system may automatically send a cancellation to the customer. These alerts can be used for sales, promotion and other time based events.

The invention provides a Meta Data Business Interface (MDBI) definition to third party applications to send and receive business information with authentication. Current methods use web bots to search and scour websites for information. A business must claim their listing or provide additional information to create a separate listing about their business. In contrast, the invention provides for a universal ability for third party applications to retrieve information about the business with varying levels of detail, for example their hours of operations, services provided, but not prices. Applications including search engines, ratings systems, and directories can use the MDBI for up to date current information. The invention creates an always up to date information interface for the business as opposed to an order of magnitude of stale information on the internet today.

The invention has a set of prebuilt infrastructure applications including an appointment management system, menus for products and services offered, promotions, logo, reviews, advertisements, circulars and catalogue, dining and beverage menus, hours of operation, tickets and event commerce, directions and locations, and extensible toolbar geometry. The MDBI can be used by third party developers to extend the applications for the business allowing for unlimited specialized functionality. In addition, user applications can be developed through the MDBI to provide enhanced user experience. The Toolbar Geometry can be used for business or user application extensions. The Toolbar can also be used for consumer application extensions.

The Façade model view of a business is the default mobile website for the business. When an end user searches for a business, clicks, touch/gestures on a link for the business or is referred to the link of a business the Façade view of the business is served. In addition, each business may be given a QR-code or other graphical representation that can be easily converted to the website address of the Façade. The business can reproduce this code and use it on their marketing material including posters and signage. The business may choose to utilize the Façade View where the invention automatically customizes the user experience for a tablet, laptop or computer as their default website. The three-dimensional model can be embedded directly in an existing website. The only requirement for the end user is a modern browser that has support for HTML5 or later technology.

Additional functionality allows users to group businesses by their affinities. The grouping of businesses by affinities is permitted on devices that can support the resolution required for a good user experience. The invention defines a set of pre-built business districts that may include entertainment, news, sports, shopping, dining and drinking establishments, and services. The districts are represented by three-dimensional models that outline a city block or other logical grouping. The user can zoom, pan, rotate, focus on a particular business Façade, or interact with interactive geometries that can launch applications. Consumer infrastructure applications can be utilized to search across multiple businesses, compare products and prices, and interact with a user's social network, including accessing another user's affinities and favorites, demographic and psychographic information, history and location information on an opt-in basis. A user can add a new business through menu or interaction with empty business space on the district view. The user is provided the ability to find a business within the genre of the district that is part of the MDBI.

The invention provides businesses a directory listing in the District(s) they participate in. When the user finds the business they are presented with one or more three-dimensional models of the business façade including corner or multi-story views. In one embodiment, the invention allows click and snap locations to place the façade model. When the façade model is placed, the façade becomes interactive with the District View. A user can change models or locations of a Façade by using click or touch/gestures to pick up the model. Special Districts called Interactive Districts allow for media, content and information to be displayed throughout a District using a Three-dimensional Model. Each Façade in a Special District could serve streaming media, blogs or other content streams. These custom districts may be used for special events or businesses that supply content as a product including news and sports organizations, one-time sporting events like Olympics, playoffs, all-star weeks, tournaments or for the duration of a concert or other event. Additional District View user applications for shopping, comparison, business affinity management, content management news-bin, and e-commerce applications are available at the District View.

A City View displays all the districts in a three dimension view of a city landscape based on a template chosen by the user. In the City View multiple pads are available to place a district; the user can select which District goes on which pad and builds their city. The City View has interactive geometries that create a dynamic interactive scene with multiple levels of detail and interaction promoting a user-experience suitable for computer or smart-television.

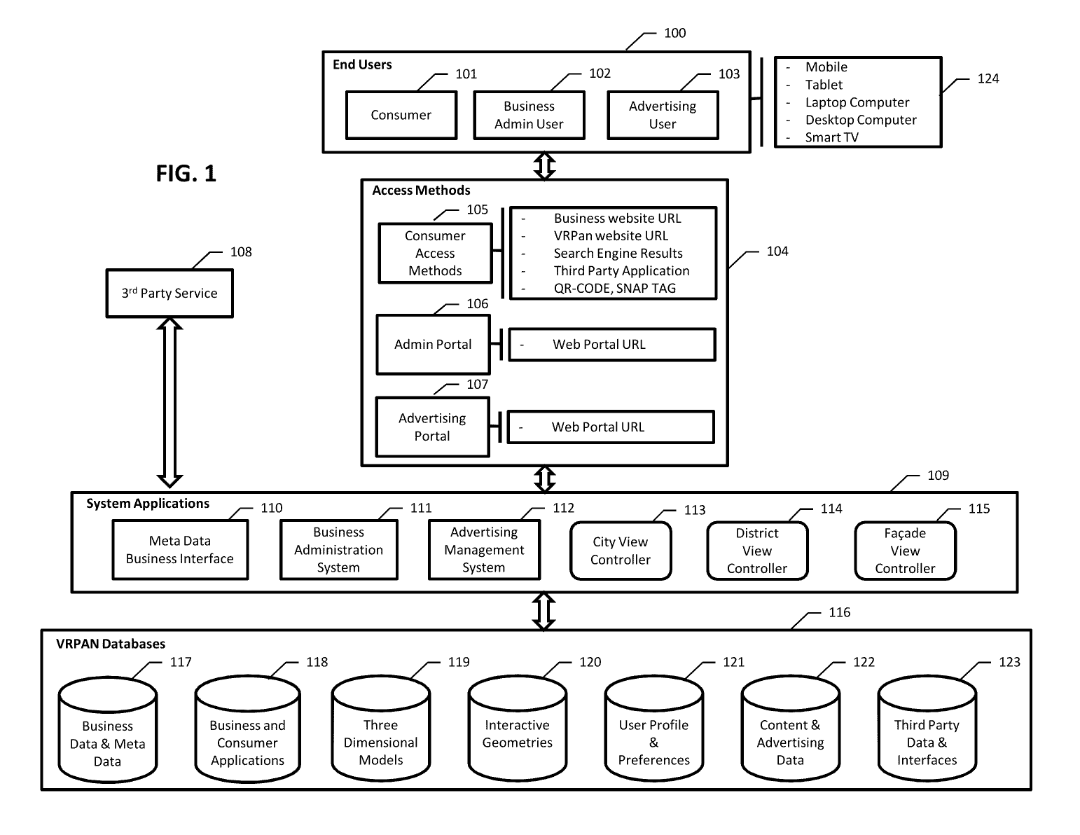

FIG. 1 is a system block diagram of one embodiment of the invention. The end users 100 interact with the system through any device that supports a modern web browser found typically on a cellular phone, laptop, tablet, desktop computer or interactive television 124. The interaction is to one or more of the system applications 109. The consumer 101 interacts with the system through links or graphical representations of links including QR-Codes, snap tags, search engine results, or the universal resource locator of the business or links on the business website or third party applications 105. The business administrative user 102 may access the system through a private and secured web portal 106 to access the business administration system 111 to make changes and modifications and publish their business content 117. An advertiser, brand or sponsor user 103 that purchases advertising on the system may enter through a private and secured web portal 107 to the advertising management system 112. Third party applications and other service providers 108 may interface to the system through an authenticated and permission based Meta Data Business Interface system 110 that provides selected business data to third party applications.

The system applications 109 interface to their corresponding Virtual Panoramic (VRPAN) databases 116 as required. Each database serves different parts of the system applications 109. The business and meta data database 117 holds information about a business and its associated infrastructure application data. The business applications database 118 holds infrastructure application code for businesses including any code from any third party or consumer applications. The three-dimensional model database 119 stores non-interactive elements of the three-dimensional models present in views of the consumer experience. The interactive geometry database 120 stores information for the interactive three-dimensional models that create a dynamic experience with the consumer and allow for the launching of infrastructure applications. The user profile and preferences database 121 stores information about the user including authentication, identity, communication preferences, affinity cards, coupons, browsing history, behavior, demographic data, psychographic data, and any other data related to a consumer's unique interaction with a business. The content and advertising database 122 stores information about third party advertisements, campaigns, analytics, billing and pricing information, as well as a real-time status. The third party data and interfaces database 123 stores information required for third party applications or services to interface and exchange information with the system.

Based upon the consumer access method 105 and the consumer's device used 124, either the façade view controller 115, district view controller 114, or city view controller 113, will be started. With the activation of any of these controllers, a sync processor updates any changes in the devices cached versions of the VRPAN databases 116 as required. This may include updates to business or consumer applications 118, business data 117, user profile and preferences 121 or other system applications or related information.

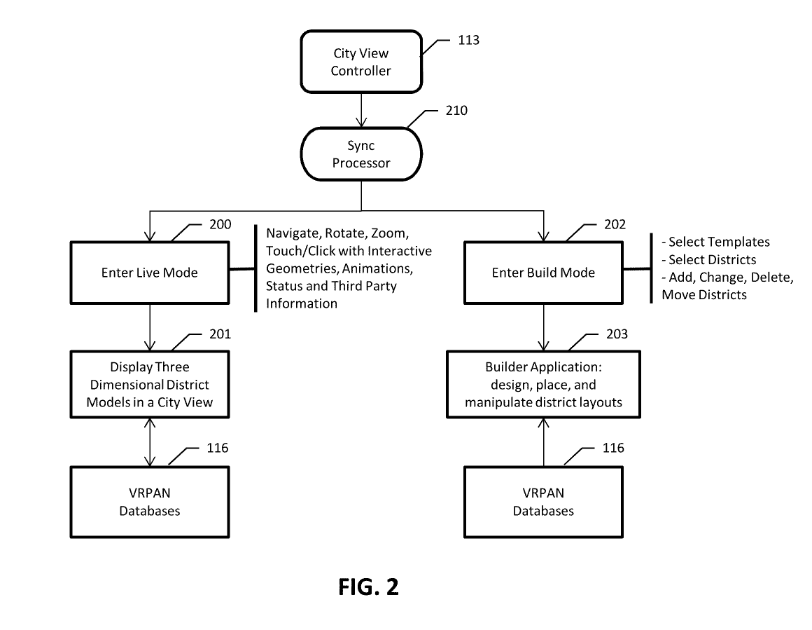

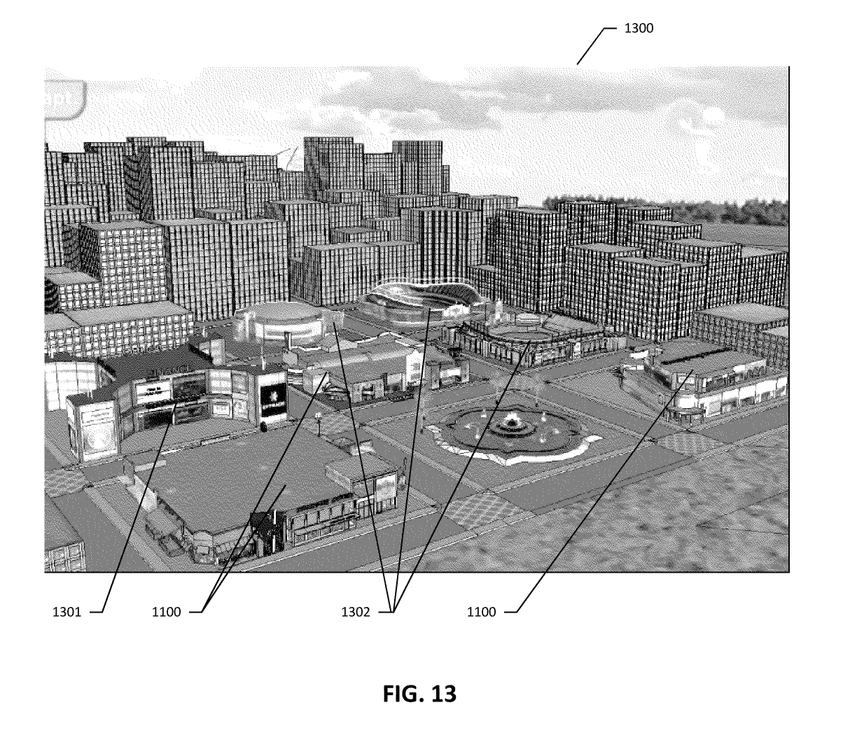

Turning to FIG. 2, If the user enters through the city view controller 113 a sync processor 210 provides a view of their city in live mode 200 as saved from their preferences 121. One embodiment of a city view 201 is illustrated in FIG. 13, where a combination of districts 1100, special interactive districts 1301, and another form of a special interactive district, represented by whole buildings or venues including stadiums and arenas 1302, are all laid out for view. In this view, a consumer can navigate, rotate zoom, touch/gesture or click on any interactive geometries that can launch or interact with an application.

Returning to FIG. 2, in addition to live mode 200 the consumer, through interacting with a Graphical User Interface (GUI) button, can enter build mode 202. In build mode, the consumer is presented with the ability to design, place and manipulate district layouts, themes and templates 203. This is facilitated through access to VRPAN databases 116.

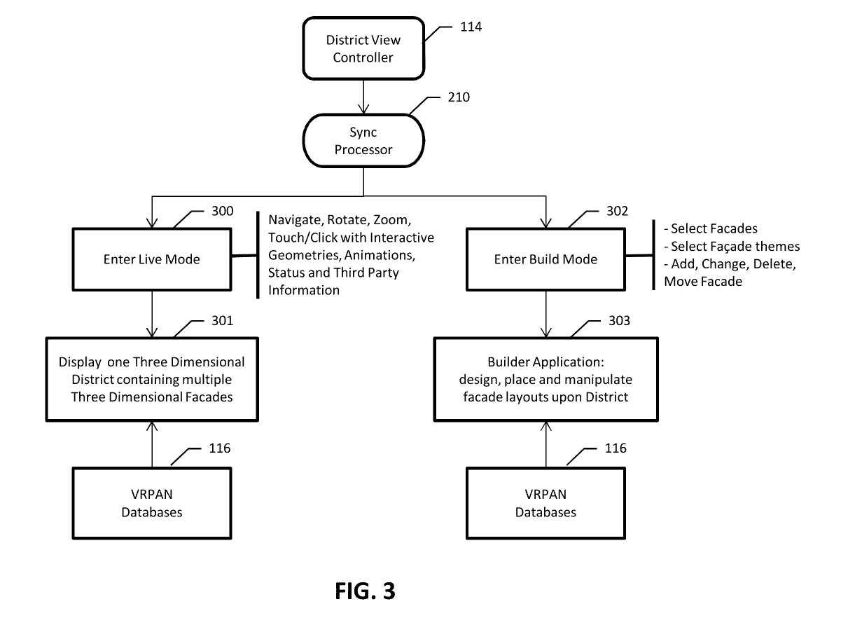

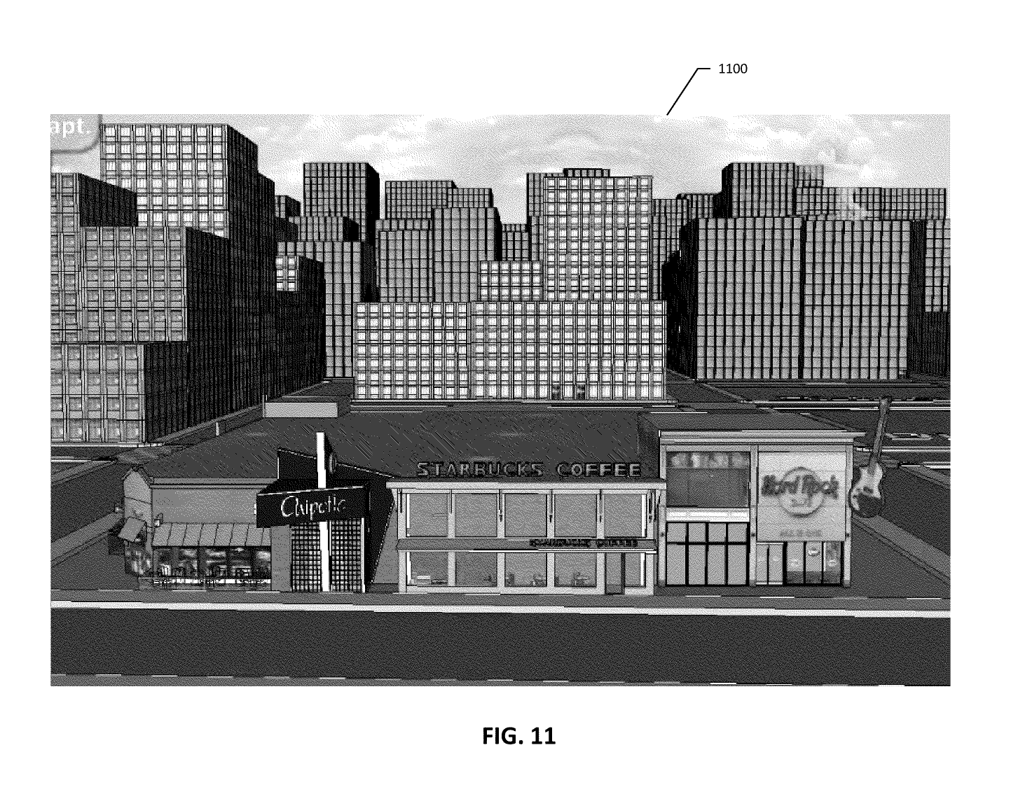

Turning now to FIG. 3, if the user enters through the district view controller 114 they are presented a view of the last district they were visiting in live mode 300 as saved from their preferences 121. One embodiment of a district view 301 is illustrated in FIG. 11. FIG. 11 illustrates a restaurant district. A consumer can navigate, rotate zoom, touch/gesture or click on any business facades or interactive geometries that can start or interact with an application. Returning to FIG. 3, in addition to live mode 300 the consumer, through interacting with a GUI button, can enter build mode 302. In build mode the consumer is now presented with the ability to design, place and manipulate business facades, search for businesses, rearrange, add or delete business facades 303 through access to VRPAN databases 116.

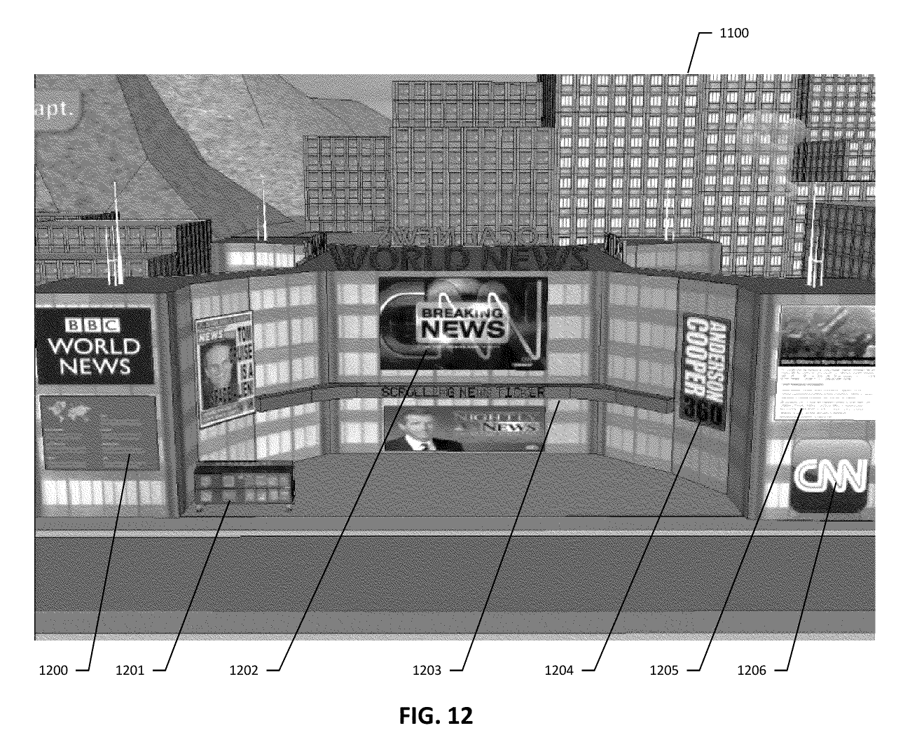

Certain districts may contain interactive districts that are customized for one district type or application. One embodiment of an interactive district is a news district as illustrated in FIG. 12. This district 1100 has custom media interactive geometries that can display text as in current news organized into categories 1200, an article repository that stores all your recent articles 1201, a breaking news streaming video player 1202, a ticker that scrolls with real-time information 1203, branding, logos and advertising can also be accommodated in a special interactive district 1204, direct news articles 1205, and also interactive geometries or direct links that launch additional applications 1206.

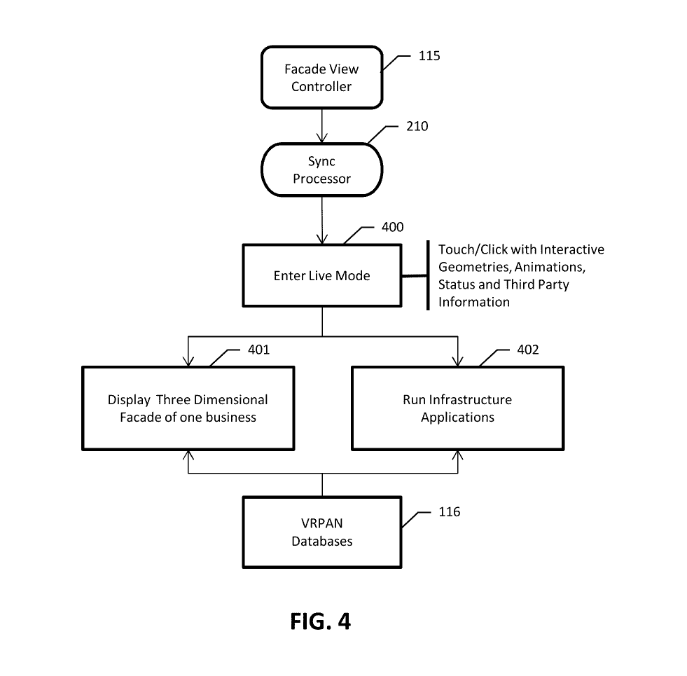

Turning now to FIG. 4, if the user enters through the façade view controller 115 the sync processor 210 will update any changes in the devices cached versions of the VRPAN databases 116 as required. The consumer is then directed to live mode 400 where the three-dimensional model of the business's façade will be displayed 401 with the associated interactive geometries and their infrastructure applications 402 as well as a toolbar comprised of a GUI overlay with interactive GUI buttons.

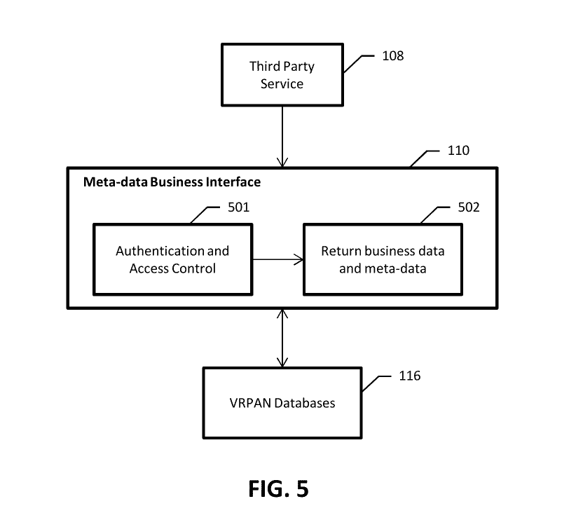

FIG. 5 illustrates that a third party service 108 may access a meta-data business interface 110, which may include an authentication and access control module 501, which accesses business data and meta-data 502. These operations may be supported by VRPAN databases 116.

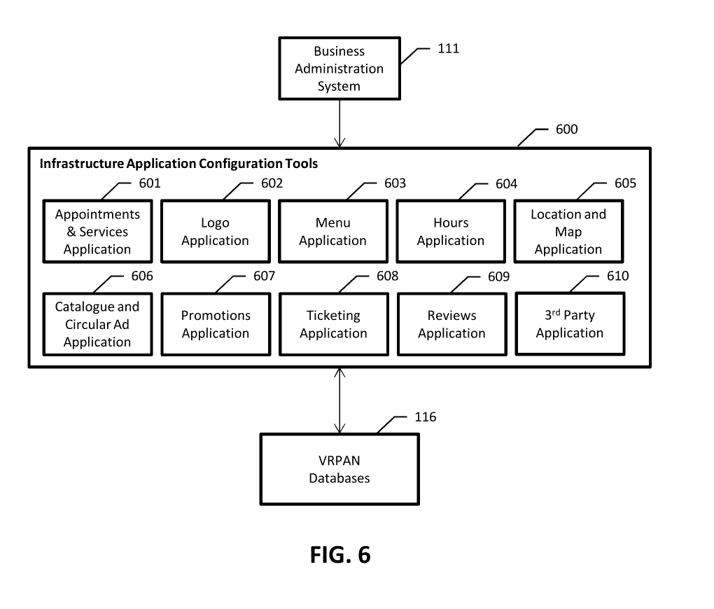

The business administrative user accesses the infrastructure application configuration tools 600 and their associated business data 117 through a secure web portal 106. The business administrative user may manage individual infrastructure applications data. As shown in FIG. 6, the appointments and services application admin application 601 allows the business to manage their stations, personnel, schedules, and offered services. The logo admin application 602 allows the business admin user the ability to update whatever data is pertinent to that application. The menu admin application 603 allows the business to manage and update their menus, including scheduling, publishing, category and sub category management, as well as individual menu item management. The hours admin application 604 allows a business to manage their hours of operation data, including specialty hours as well as scheduling and publishing of the hour sets. The location and map admin application 605 allows the business to manage multiple business locations, as well as manage contact persons for those businesses. The catalogue admin application 606 allows the business to manage their entire catalogue of offered products, including scheduling and publishing of specific catalogue, category and sub category management, as well as individual product management. The promotions admin application 607 allows the business to manage their own ad campaigns including placement, scheduling, publishing, content, and analytics. The ticketing admin application 608 may interface with third party ticketing applications and allow a business to update and manage any available data required by the third party app. The reviews admin application 609 may allow the business to view and manage their review scores from multiple review services, also allowing for the setup of alerts based upon posted review scores. Any third party admin application 610 may allow a business to manage any relevant selected data for that application.

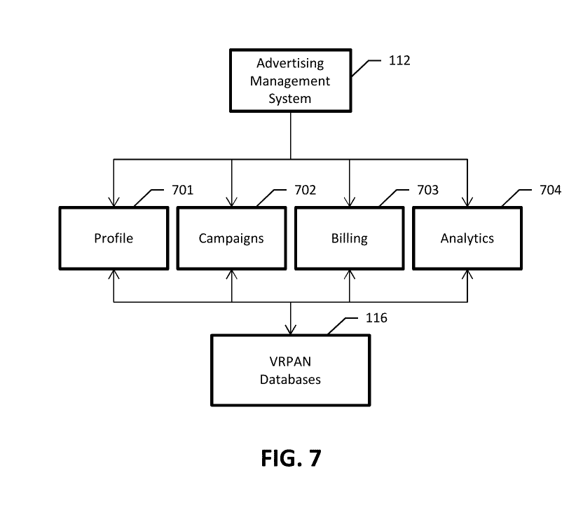

The advertising user accesses the advertising management system 112, as shown in FIG. 7. Access may be through a secure web portal 107. The advertising admin user may be presented a menu of options to manage their advertising profile 701, campaigns 702, billing 703, and analytics 704. These operations are supported by VRPAN databases 116.

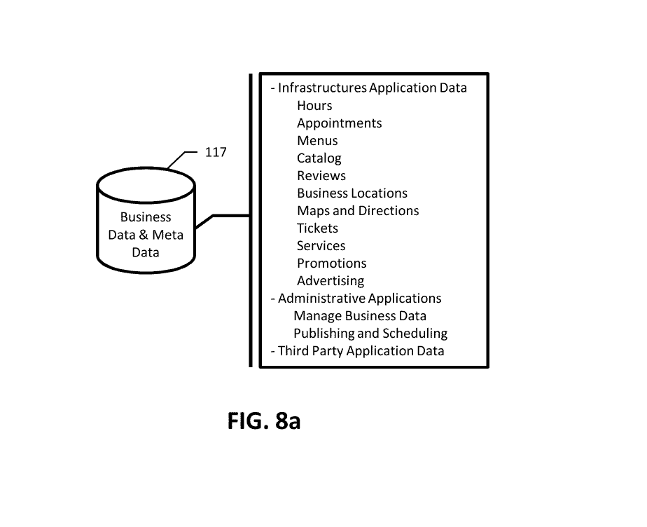

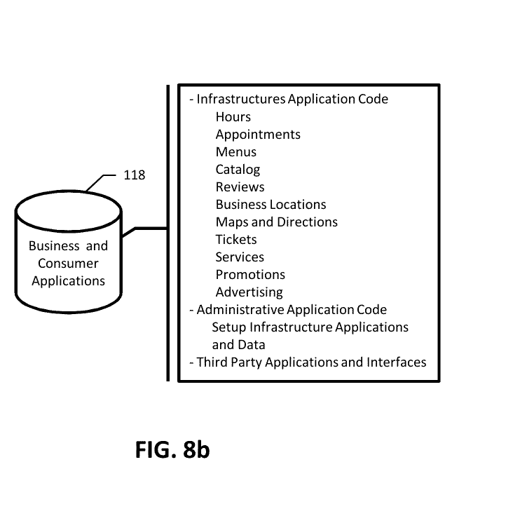

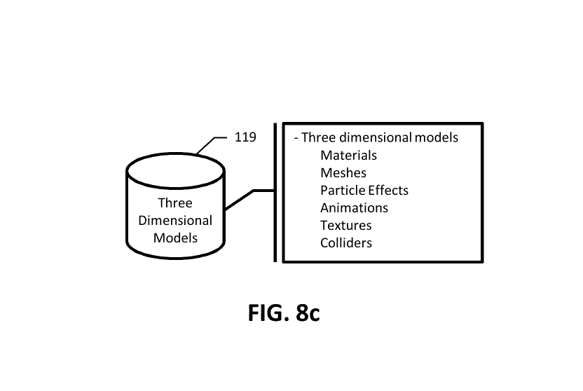

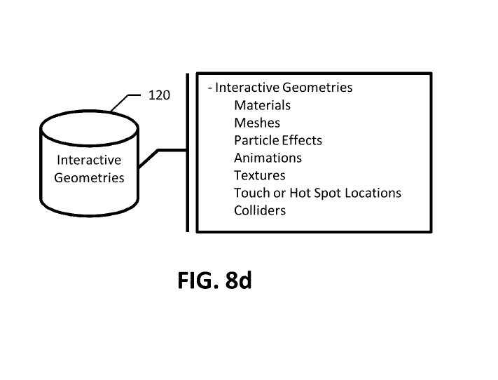

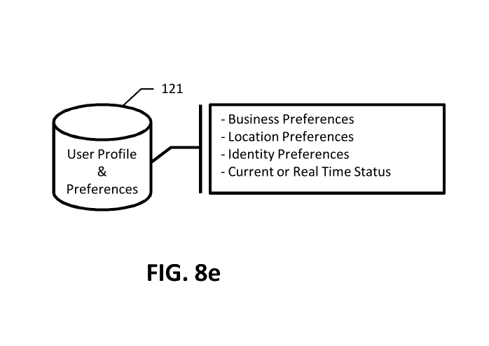

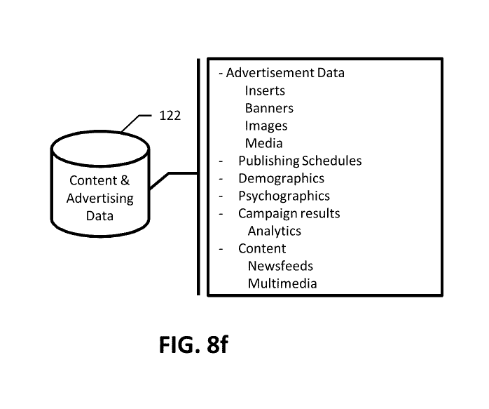

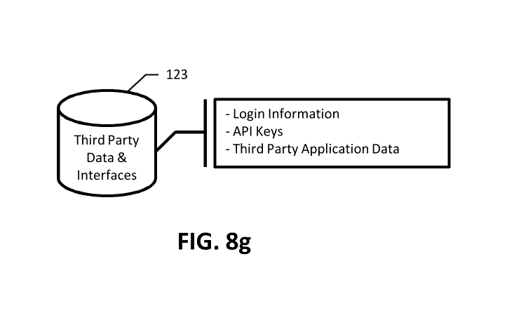

FIG. 8a illustrates exemplary business data and meta-data 117 that may be used in accordance with an embodiment of the invention. FIG. 8b illustrates business applications 118 that may be used in accordance with an embodiment of the invention. FIG. 8c illustrates that three-dimensional models 119 may include materials, meshes, particle effects, animations, textures and colliders. FIG. 8d illustrates interactive geometries 120 that may include similar elements. FIG. 8e illustrates user profile and preferences 121 that may be used in accordance with an embodiment of the invention. FIG. 8f illustrates content and advertising data 122 that may be used in accordance with embodiments of the invention. FIG. 8g illustrates third party data and interfaces 123, such as login information, API keys and third party application data.

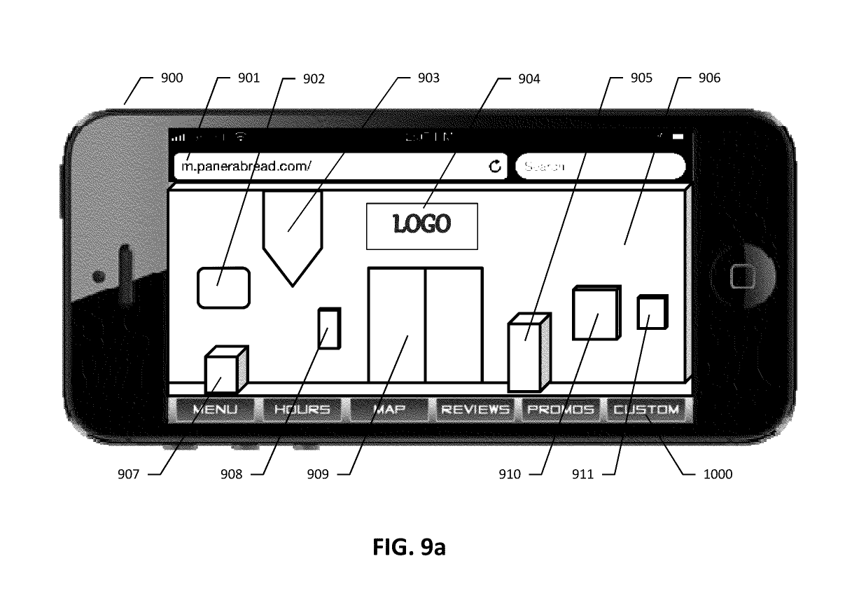

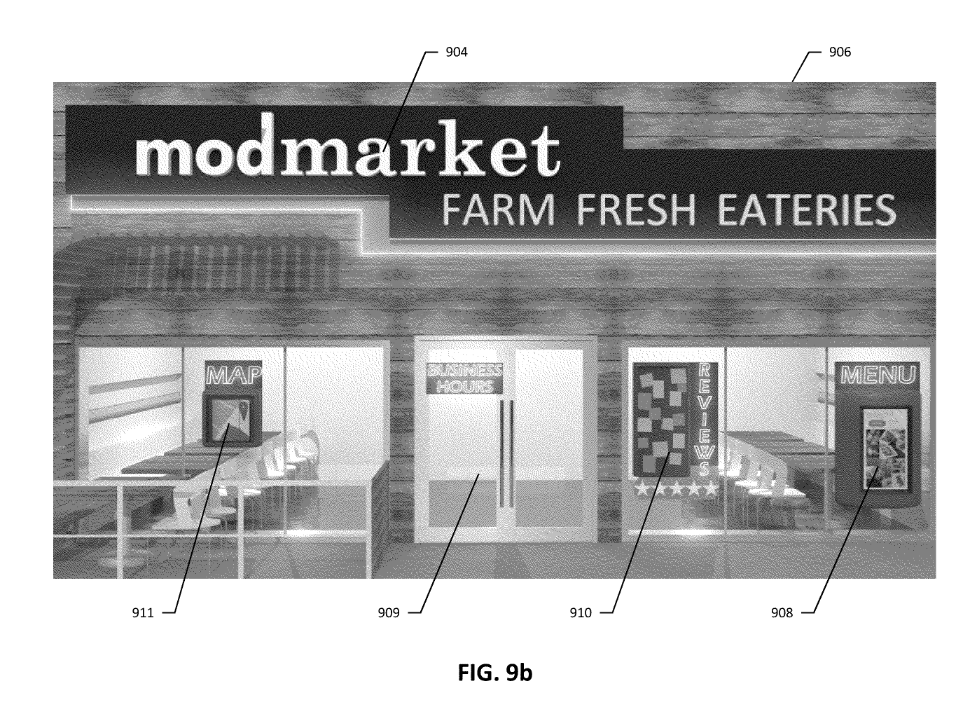

This infrastructure supports the three-dimensional landscape views utilized in accordance with the invention. These landscape views may be resolved at the city level, the district level and the individual façade level. From the façade view the consumer can launch one or more infrastructure applications that are part of the interactive geometries shown in FIGS. 9a and 9b. Infrastructure applications associated with interactive geometries could include menus, business hours, locations, appointments and services, catalogues, reviews, maps and directions, promotions, advertising, tickets, or other business applications as developed.

FIG. 9a represents a sample user interface 900. A user is directed to a three-dimensional façade view of a business through a variety of methods, in this example a URL 901. The invention displays a three-dimensional façade 906 and the interactive geometries associated with it. These interactive geometries include: appointments and services 902 which is displayed to the user as a model of an appointment window and hosts an application which interacts with current scheduling applications including, but not limited to, iOS™ calendars and Google™ calendars. Service, personnel, and time selection ability as well as quotes and estimates for offered services are available in this application. The promotions interactive geometry 903 is displayed to the user as a model of a banner, sign, placard, or other mixed media. These models host applications which display sales, event, and other promotions to the user for conversion ability, including coupons and redeemable offers for the façade's host business or other businesses. The business' logo 904 may be a model representation of a business logo and may host third party applications customized on a per business basis. The tickets interactive geometry 905 is represented by a model resembling a ticket kiosk and may host third party ticket applications for ticket purchases related to the business. The catalog interactive geometry 907 is a model designed to resemble a news rack, which may host applications featuring a business' offered products, weekly specials, or other associated product offer sheet displayed in a page turn-able book format. The menu interactive geometry 908 is a model designed as a menu within a glass case and hosts an application that displays a businesses offered menu items in a category, list, or tile view to the user. The hours interactive geometry 909 may be the doors of any three-dimensional façade and when interacted with may host an application displaying a business' hours of operation, as well as specialty hours, with the ability to have certain hours visible based upon time of day or date.

The reviews interactive geometry 910 may be a model resembling a cork board of notes and a rating system of stars. The reviews interactive geometry 901 may host an application that aggregates reviews from known review sources such as Google+™ and Yelp™.

The map interactive geometry 911 may be a model resembling a map dispenser and when interacted with may display a map and directions to the business for the user, as well as offer other locations of the business with links to their three-dimensional façade views if different from the current façade view being viewed. FIG. 9b shows a sample three-dimensional façade with its associated interactive geometries.

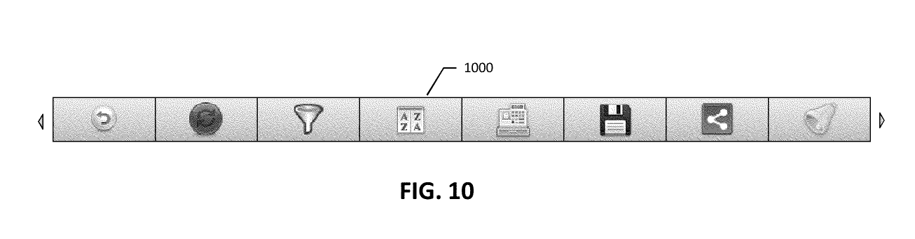

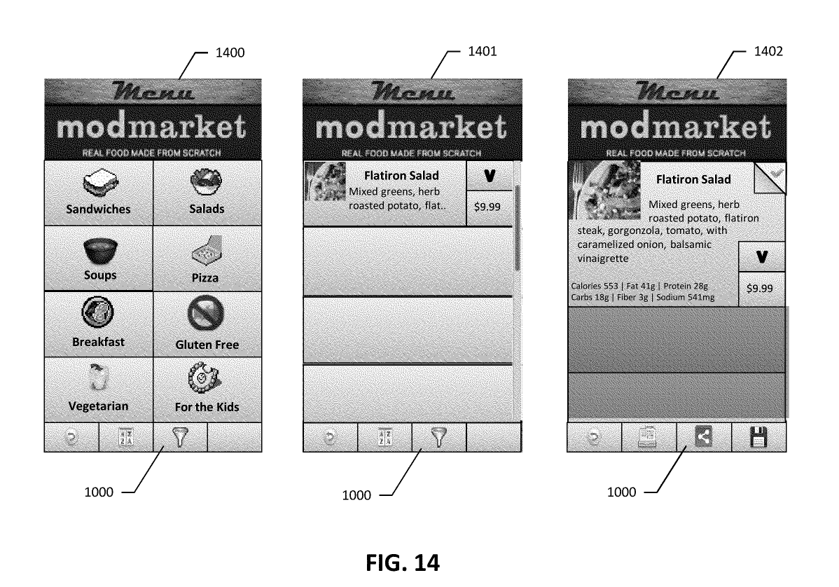

FIG. 10 illustrates a toolbar 1000 that may be used in accordance with an embodiment of the invention. FIG. 14 demonstrates a sample menu application, specifically displaying a categorical view 1400, a list view 1401, and a tile view 1402.

A consumer can utilize each business façade independent of any other activities as a stand-alone web site through a standard browser. The district views and city views are optional components designed to help organize a consumer's affinities with businesses and provides a compelling desktop or tablet application.

An embodiment of the present invention relates to a computer storage product with a non-transitory computer readable storage medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media, optical media, magneto-optical media and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using JAVA®, C++, or other object-oriented programming language and development tools. Aspects of the invention may also be implemented using HyperText Transport Protocol (HTTP), Procedural Scripting Languages and the like. Three-dimensional rendering engines and three-dimensional modeling tools may also be used in accordance with embodiments of the invention. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

What is claimed is:

1. A non-transitory computer readable storage medium with executable instructions to define:
a landscape of discrete three-dimensional structures, wherein each three-dimensional structure belongs to one of a plurality of defined business segments, wherein each business segment has predetermined façade attributes and wherein each façade attribute provides interactive access to information about a business.

2. The non-transitory computer readable storage medium of claim 1 wherein the interactive access to information about the business is a hosted business application.

3. The non-transitory computer readable storage medium of claim 2 wherein the hosted business application includes a set of business information templates configurable by a user.

4. The non-transitory computer readable storage medium of claim 3 wherein a business information template provides a template to supply business information.

5. The non-transitory computer readable storage medium of claim 3 wherein a business information template provides a template to support a business transaction.

6. The non-transitory computer readable storage medium of claim 1 wherein the landscape is configurable by a user.

7. The non-transitory computer readable storage medium of claim 1 wherein the plurality of defined business segments constitutes a district and the landscape includes a plurality of districts constituting a city.

8. The non-transitory computer readable storage medium of claim 7 wherein the plurality of districts includes different themes.

9. The non-transitory computer readable storage medium of claim 7 wherein the plurality of districts includes different landscapes.

10. The non-transitory computer readable storage medium of claim 1 wherein a selected façade attribute is populated with content from a third party application.

11. The non-transitory computer readable storage medium of claim 1 wherein the landscape is tailored for an end-user device.

12. The non-transitory computer readable storage medium of claim 1 wherein the landscape includes individually configurable business segments.

13. The non-transitory computer readable storage medium of claim 12 wherein an individually configurable business segment is selected from news, entertainment, retail, dining, sports and specified services.

14. The non-transitory computer readable storage medium of claim 1 further comprising a meta-data business interface to publish business information and content to third party services and applications as a hosted repository.

15. The non-transitory computer readable storage medium of claim 1 further comprising applications and interfaces to the landscape.

16. The non-transitory computer readable storage medium of claim 1 further comprising social media interfaces to the landscape.
